(19) United States
(12) Patent Application Publication
(10) Pub. No.: US 2022/0351089 A1
(43) Pub. Date: Nov. 3, 2022

(54) SEGMENTING UNSTRUCTURED TEXT

(71) Applicant: International Business Machines Corporation, Armonk, NY (US)

(72) Inventor: Tin Kam Ho, Millburn, NJ (US)

(21) Appl. No.: 17/306,535

(22) Filed: May 3, 2021

(51) Int. Cl. G06N 20/20; G06K 9/62; G06F 40/205

(52) U.S. Cl. CPC G06N 20/20; G06K 9/6256; G06F 40/205

(57) ABSTRACT

A system and method for segmenting text by receiving a machine learning (ML) model for language processing, receiving segmentable text including properly joined segments, separating properly joined segments of the text into separate segments, generating positive segment pairs including properly joined segments, generating negative sentence fragment pairs including a first segment and a second segment, where the first segment and the second segment are not properly joined, and training the ML model using the positive segment pairs and the negative segment pairs, and a contrastive self-supervised learning framework training objective loss function.

### FIELD OF THE INVENTION

The disclosure relates generally to the segmentation of unstructured text for language processing. The disclosure relates particularly to training one or more machine learning models to segment unstructured text as a prelude to further language processing.

### BACKGROUND

Systems for segmenting input text into sentences, paragraphs and related sections may rely upon headers within the text as well as the grammatical structure of the text in conducting the segmentation. Such systems depend upon the presence of regular expressions and proper punctuation within target texts.

### SUMMARY

The following presents a summary to provide a basic understanding of one or more embodiments of the disclosure. This summary is not intended to identify key or critical elements or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatuses and/or computer program products enable segmentation of input texts lacking proper formatting and/or punctuation.

Aspects of the invention disclose methods, systems and computer readable media associated with segmenting text by receiving a machine learning (ML) model for language processing, receiving segmentable text including properly joined segments, separating properly joined segments of the text into separate segments, generating positive segment pairs including properly joined segments, generating negative sentence fragment pairs including a first segment and a second segment, where the first segment and the second segment are not properly joined, and training the ML model using the positive segment pairs and the negative segment pairs, and a contrastive self-supervised learning framework training objective loss function. For example, complete sentences of the input text may be separated into sentence fragments, complete paragraphs of input text may be separated into separate sentences. Sentence fragments and sentences may then be combined to form positive and negative segment pairings for use in training machine learning models.

Aspects of the invention disclose methods, systems and computer readable media associated with segmenting text by receiving a machine learning (ML) model for language processing, receiving segmentable text, separating complete sentences of the text into sentence fragments, wherein the method separates each sentence into at least two sentence fragments, generating positive sentence fragment pairs including sentence fragments from a single sentence, generating negative sentence fragment pairs including a first sentence fragment from a first sentence and a second sentence fragment from a second sentence, training the ML model using the positive sentence fragment pairs and the negative sentence fragment pairs, and a contrastive self-supervised learning framework training objective function, and providing the trained ML model for segmenting text.

Aspects of the invention disclose methods, systems and computer readable media associated with segmenting text by receiving a machine learning (ML) model for language processing, receiving segmentable text, separating paragraphs of the text into complete sentences, wherein the method separates paragraphs into at least two sentences, generating positive sentence pairs including sentences from a single paragraph, generating negative sentence pairs including a first sentence from a first paragraph and a second sentence from a second paragraph, training the ML model using the positive sentence pairs and the negative sentence pairs, and a contrastive self-supervised learning framework training objective function, and providing the trained ML model for segmenting text. In an embodiment, a paragraph consisting of a single sentence forms a part of a negative sentence pairing when combined with a sentence from another paragraph.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 provides a schematic illustration of a computing environment, according to an embodiment of the invention.

FIG. 2 provides a flowchart depicting an operational sequence, according to an embodiment of the invention.

FIG. 3 depicts a cloud computing environment, according to an embodiment of the invention.

FIG. 4 depicts abstraction model layers, according to an embodiment of the invention.

### DETAILED DESCRIPTION

Some embodiments will be described in more detail with reference to the accompanying drawings, in which the embodiments of the present disclosure have been illustrated. However, the present disclosure can be implemented in various manners, and thus should not be construed to be limited to the embodiments disclosed herein.

Generating data summaries from unstructured texts can be problematic. Relevant information may exist in the text in a variety of formats including paragraphs, lists, or tables, following differing rules or standards for the use of headers and other formatting conventions. A single overall input text may include documents from diverse sources lacking any consistency in formatting across the set of documents with no clear guidance regarding the formatting used in the set.

Properly dividing a set of diverse documents, such as patient's medical history across multiple providers and medical staffers requires dividing the overall set of documents according to content type, e.g., diagnosis, medical history, family history, medication lists, etc. Within a single document or section of a single document, there may be complete sentences, stand-alone phrases, lists, or tables of critical information.

Target texts, such as patient clinical charts, may not follow consistent or formal formatting standards. Such texts may also fail to follow standard grammatical or punctuation rules in their presentation of critical information. The development of a corresponding training data set for use in developing a machine learning model to automatically segment input text represents a time and resource intensive task without a clear path to a successful outcome. Disclosed embodiments enable the development of a trained machine learning model for the segmentation of diverse and unstructured input texts without the need to generate a resource intensive training data set. Such a model provides outputs of input texts segmented to combine related phrases, sentences and paragraphs into a more coherent summary of the input text.

Aspects of the present invention relate generally to the training of one or more machine learning models for the purpose of segmenting input text regardless of any lack of structure in the input text. Such a trained model then segments new input texts, providing a reorganized version of the input text where related portions of the input text are combined. The availability of large language models, including BERT (Bidirectional Encoder Representations from Transformers), Generative Pre-trained Transformer (GPT)-x, and Megatron, enables the development of appropriate segmentation models through fine tuning tasks associated with such models. In embodiments, training texts, analogous to, or otherwise similar in structure to, the downstream target texts, are processed by disclosed embodiments to generate positive and negative training text data for developing the machine learning based segmentation model. The method then uses positive and negative training text data, together with a loss function, such as a noise contrastive estimator, to training a machine learning model to segment input texts. The method then applies the trained model to new input texts, yielding appropriately segmented versions of the input texts.

Aspects of the invention include methods segmenting sentences of input text into sentence fragments. Sentence fragment pairs combined from a single sentence constitute positive training pairings and sentence fragments combined from disparate sentences constitute negative training pairings. Disclosed methods then train a first machine learning model for segmenting input using the positive and negative sentence fragment pairings, or, in other words, finding the correct sentence boundaries of the input text.

Aspects of the invention include methods segmenting paragraphs of input text into sentences. Sentence pairs combined from a single paragraph constitute positive training pairings and sentences combined from disparate paragraphs constitute negative training pairings. Disclosed methods then train a second machine learning model for segmenting input into semantically coherent paragraphs or sections, using the positive and negative sentence pairings. In this embodiment, sentences of the input text may be grouped into coherent paragraphs and the paragraphs may be grouped into topically consistent sections.

Aspects of the invention provide an improvement in the technical field of text segmentation through the training and provision of machine learning models enabled to appropriately segment unstructured input texts, such as a collection of documents making up a patient's treatment history. Such trained models improve the functioning of natural language understanding (NLU), or natural language processing (NLP) systems used downstream from the model. Such systems benefit from appropriately segmented input texts in performing their individual analyses of the segmented text data.

Aspects of the invention also provide an improvement to computer functionality. In particular, implementations of the invention are directed to a specific improvement to the way NLP and NLU systems operate. Such systems have difficulty analyzing unstructured data as such data fails to conform to the language patterns of the text data used in training the specific NLU or NLP analysis model. Disclosed embodiments provide consistently segmented outputs from unstructured input texts. Such consistently segmented outputs serve as the inputs to the downstream NLU or NLP system, improving the consistency of the output of the downstream systems.

As an overview, NLU and NLP systems evaluate text data looking for patterns matching defined classifications of the model. Such models are generally trained using structures and properly segmented text data. As such, NLU and NLP systems have limited capacities for the correct evaluation of unstructured, poorly or improperly segmented text data. Disclosed embodiments bridge this gap between unstructured real text data from specific categories, e.g., patient data, and downstream NLU and NLP systems by appropriately segmenting the unstructured input data. Disclosed embodiments train models to accept the unstructured text data and output properly segmented data for the downstream analysis models.

In an embodiment, one or more components of the system can employ hardware and/or software to solve problems that are highly technical in nature (e.g., receiving a machine learning (ML) model for language processing, receiving segmentable text including properly joined segments, separating properly joined segments of the text into separate segments, generating positive segment pairs including properly joined segments, generating negative sentence fragment pairs including a first segment and a second segment, where the first segment and the second segment are not properly joined, training the ML model using the positive segment pairs and the negative segment pairs, and a contrastive self-supervised learning framework training objective loss function, etc.). These solutions are not abstract and cannot be performed as a set of mental acts by a human due to the processing capabilities needed to facilitate automated segmentation of unstructured text data, for example. Further, some of the processes performed may be performed by a specialized computer for carrying out defined tasks related to automatically segmenting text data. For example, a specialized computer can be employed to carry out tasks related to text segmentation or the like.

In an embodiment, disclosed methods train text segmentation machine learning models applicable to unstructured text data from generic text segmentation models including deep neural network (DNN), convolutional neural network (CNN) recurrent neural network (RNN) architectures as well as generative architectures such as variational autoencoders and generative adversarial networks. Large language model, such as BERT, GPTx, Megatron, and biomedical variants of these, including bioBERT, bioCliniclaBERT, and BioMegatron, provide a starting point for disclosed methods in training a text segmentation model for unstructured text.

From the generic large language model, the method proceeds with two tasks to fine tune models for text segmentation. In an embodiment, one model training task initially focuses upon segmenting training text into sentences and a second model training task initially focuses upon segmenting input text into multi-sentence paragraphs or larger sections. In this embodiment, the method begins with the generic large language model and a training dataset including labeled, cleaned, segmentable text data. As used herein, cleaned segmentable text data refers to text data with any unstructured aspects, such as poor or improper segmenting of sentences and/or paragraphs, lack of headings, poor grammatical structure of punctuation, revised or removed. Such a dataset comprises text data which may be segmented into sentences and larger sections of related content. The segments of the cleaned segmentable text include sentences properly joined into paragraphs, and sentence fragments properly joined into sentences. In contrast a combination including a first fragment from a first sentence, and a second sentence fragment from a different sentence would not be properly joined to form a complete sentence. Similarly, sentences from different paragraphs would not be properly combined to form a paragraph. Such improper combinations of segments serve as negative segment pairing in the training of disclosed machine learning models.

In an embodiment, in the first task, the method identifies complete sentences of the training text dataset, and divides each identified complete sentence into two or more sentence fragments, such as (sentence fragment) SF1, SF2, etc. In this embodiment, the method uses the generic language model or other NLP model to identify the complete sentences of the cleaned training dataset.

In an embodiment, the method combines sentence fragments into sentence fragment pairs. In this embodiment, the method re-combines sentence fragments from a single sentence into a positive pair indicating that joining the two fragments constitutes a positive model outcome. The model combines sentence fragments from different sentences into a negative pair indicating that the combination of sentence fragments from different sentences represents a negative model outcome.

In this embodiment, the method trains the generic language model using the sets of positive and negative sentence fragment pairings as labeled data for the model's training dataset. In this embodiment, the method uses a contrastive self-supervised learning framework for training the model with a loss function as the training objective.

In an embodiment, in the second task, the method identifies paragraphs of the training text dataset, and divides each identified paragraph into two or more sentences, such as (sentence) S1, S2, etc. In this embodiment, the method uses the generic language model or other NLP model to identify the complete paragraphs of the cleaned training dataset.

In an embodiment, the method combines individual sentences into sentence pairs. In this embodiment, the method re-combines sentences from a single paragraph into a positive sentence pair indicating that joining the two sentences constitutes a positive model outcome. In this embodiment, the model combines sentences from different paragraphs into a negative sentence pair, indicating that the combination of sentence fragments from different sentences represents a negative model outcome. In an embodiment, the method uses consecutive sentences from a single paragraph to form positive sentence pairs.

In this embodiment, the method trains the generic language model using the sets of positive and negative sentence pairings as labeled data for the model's training dataset. In this embodiment, the method uses a contrastive self-supervised learning framework for training the second paragraph-based model with a loss function as the training objective.

In an embodiment, training the model includes the use of noise contrastive estimator (NCE) loss function, where:

$${NCE}_{Loss} = - log \frac{exp ( sim ( g ( x ) , g ( {x}^{+} ) ) )}{exp ( sim ( g ( x ) , g ( {x}^{+} ) ) ) + {\sum }_{k = 1}^{K} exp ( sim ( g ( x ) , g ( {x}_{k}^{-} ) ) )}$$

and (x, x⁺) constitutes a positive pair of combined sentence fragments or sentences, (x, x⁻) onstitutes a negative pair of sentence fragments or sentences, and sim(x,y) constitutes a similarity functions such as a similarity between sentence or sentence fragment pairings, based on the embedding vectors of x and y as given by the encoder g(.). Examples of methods of determining the similarity of text-based documents include Jaccard distance, Cosine distance, Euclidean distance, Relaxed Word Mover's Distance. A person of ordinary skill in the art may apply other techniques of determining similarity between sentence or sentence fragment pairings of a document other than those presented, herein, and not deviate from or limit the features of embodiments of the present invention. The method uses the NCE loss function together with the labeled positive and negative data pairing and logistic regression models to determine the node weights for the trained network. In this embodiment, the NCE loss function-based model yields a predicted probability that two sentences or sentence fragments of text data should be joined. In an embodiment, methods provide the trained model(s) for use on new text data as a prelude to additional downstream language processing by a system such as an NLP or NLU.

In an embodiment, the method provides the trained model for use segmenting new text data. In this embodiment, the method receives the new text data and utilizes the trained models to analyze and segment the data. The models yield one or more segmentation results for the data including joining sentence portions and sentences of the data together due to similar content, separating two sentence portions or sentences of the data due to dissimilar content, and retaining a current relationship—joined or separated, between two sentence portions or sentences of the data as the level of similarity/dissimilarity of the sentence fragment or sentence pairing conforms to the current relationship of the pairing.

In an embodiment, the method further trains a second machine learning model to segment text in multi-sentence portions. In this embodiment, the method analyzes the cleaned training data and identifies multi-sentence sequences of at least two sentences from a single paragraph as positive pairings, while identifying sequences formed from at least two sentences taken from at least two different paragraphs, as negative sentence pairings. The method proceeds as described above to train the model to identify and then segment multiple sentence portions (paragraphs) of the data. In an embodiment, the method provides the expanded set of trained models, adapted to segment input text not only into sentence fragments but also multi-sentence paragraphs and larger sections. In this embodiment, the provided trained models analyze the similarity between sentence fragments, and sentences, according to the trained network weights derived from analysis of the training dataset of positive and negative sentence fragment and complete sentence pairings. The trained model set segments the new input text data according to the level of similarity. In this embodiment, the method derives a similarity threshold for each of the sentence fragment and complete sentence pairings with the thresholds indicating the transition point between similar pairings which should be joined if not already sequential, and dissimilar pairings which should not be joined, or separated if currently joined.

During analysis, the trained model determines the NCE loss function value for text portion pairings of the new text data. Loss function values below the defined threshold result in separated text portions while loss function predictions above the threshold result in joined text portions. One or more statistical smoothing functions may be added to the model as a way of reducing the effect of minor fluctuations in new text data upon the decisions to separate or join text portions of the new data. Each of two trained models may be applied to the new input text. The first model segments sentence fragments, combining or separating the sentence fragments according to the model. A second ML model combines or separates sentences of the input text according to the model.

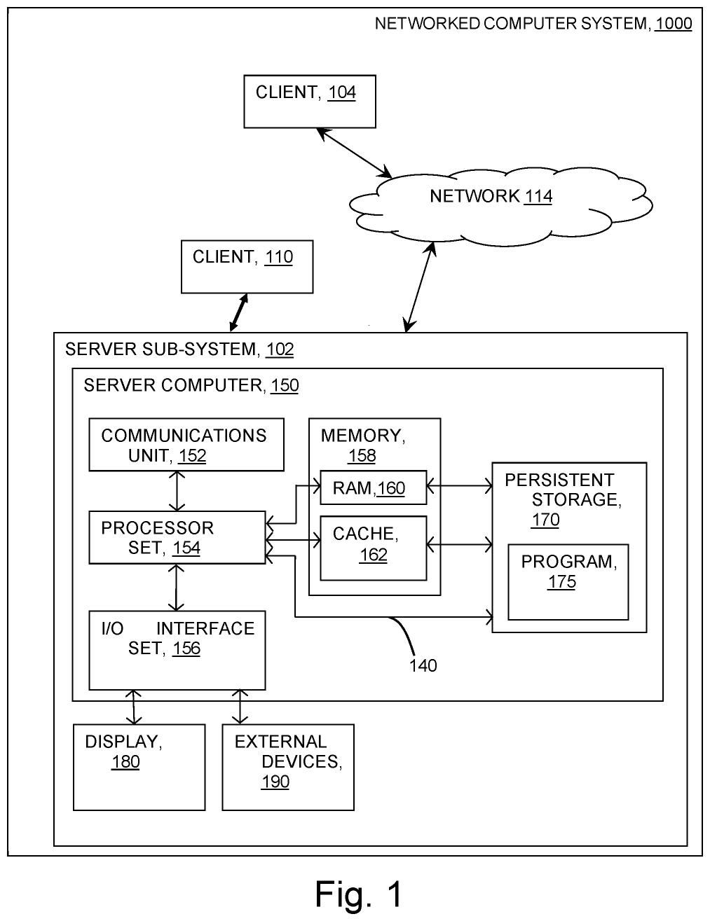

FIG. 1 provides a schematic illustration of exemplary network resources associated with practicing the disclosed inventions. The inventions may be practiced in the processors of any of the disclosed elements which process an instruction stream. As shown in the figure, a networked Client device 110 connects wirelessly to server sub-system 102. Client device 104 connects wirelessly to server sub-system 102 via network 114. Client devices 104 and 110 comprise text segmentation application program (not shown) together with sufficient computing resource (processor, memory, network communications hardware) to execute the program. As shown in FIG. 1, server sub-system 102 comprises a server computer 150. FIG. 1 depicts a block diagram of components of server computer 150 within a networked computer system 1000, in accordance with an embodiment of the present invention. It should be appreciated that FIG. 1 provides only an illustration of one implementation and does not imply any limitations with regard to the environments in which different embodiments can be implemented. Many modifications to the depicted environment can be made.

Server computer 150 can include processor(s) 154, memory 158, persistent storage 170, communications unit 152, input/output (I/O) interface(s) 156 and communications fabric 140. Communications fabric 140 provides communications between cache 162, memory 158, persistent storage 170, communications unit 152, and input/output (I/O) interface(s) 156. Communications fabric 140 can be implemented with any architecture designed for passing data and/or control information between processors (such as microprocessors, communications and network processors, etc.), system memory, peripheral devices, and any other hardware components within a system. For example, communications fabric 140 can be implemented with one or more buses.

Memory 158 and persistent storage 170 are computer readable storage media. In this embodiment, memory 158 includes random access memory (RAM) 160. In general, memory 158 can include any suitable volatile or non-volatile computer readable storage media. Cache 162 is a fast memory that enhances the performance of processor(s) 154 by holding recently accessed data, and data near recently accessed data, from memory 158.

Program instructions and data used to practice embodiments of the present invention, e.g., the text segmentation program 175, are stored in persistent storage 170 for execution and/or access by one or more of the respective processor(s) 154 of server computer 150 via cache 162. In this embodiment, persistent storage 170 includes a magnetic hard disk drive. Alternatively, or in addition to a magnetic hard disk drive, persistent storage 170 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 170 may also be removable. For example, a removable hard drive may be used for persistent storage 170. Other examples include optical and magnetic disks, thumb drives, and smart cards that are inserted into a drive for transfer onto another computer readable storage medium that is also part of persistent storage 170.

Communications unit 152, in these examples, provides for communications with other data processing systems or devices, including resources of client computing devices 104, and 110. In these examples, communications unit 152 includes one or more network interface cards. Communications unit 152 may provide communications through the use of either or both physical and wireless communications links. Software distribution programs, and other programs and data used for implementation of the present invention, may be downloaded to persistent storage 170 of server computer 150 through communications unit 152.

I/O interface(s) 156 allows for input and output of data with other devices that may be connected to server computer 150. For example, I/O interface(s) 156 may provide a connection to external device(s) 190 such as a keyboard, a keypad, a touch screen, a microphone, a digital camera, and/or some other suitable input device. External device(s) 190 can also include portable computer readable storage media such as, for example, thumb drives, portable optical or magnetic disks, and memory cards. Software and data used to practice embodiments of the present invention, e.g., text segmentation program 175 on server computer 150, can be stored on such portable computer readable storage media and can be loaded onto persistent storage 170 via I/O interface(s) 156. I/O interface(s) 156 also connect to a display 180.

Display 180 provides a mechanism to display data to a user and may be, for example, a computer monitor. Display 180 can also function as a touch screen, such as a display of a tablet computer.

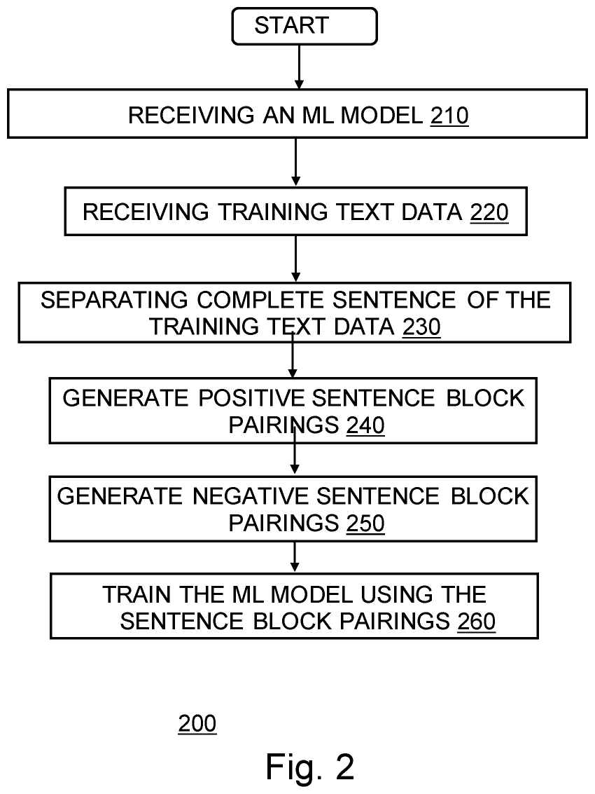

FIG. 2 provides a flowchart 200, illustrating exemplary activities associated with the practice of the disclosure. After program start, at block 210, the method executing the text data segmentation program 175 using a computing environment such as that of FIGS. 1, 3, and 4, receives a generic ML language model. The method then fine tunes the generic model as follows.

At block 220, the method receives cleaned segmentable training text data. This text data conforms to grammar and punctuation rules and contains complete sentences and well structured and consistent paragraphs and topical sections. Segments of the text, including sentence fragments and sentences, are properly joined to form complete sentences and well structured and consistent paragraphs.

At block 230, the method identifies complete sentences in the training data and separates the identified complete sentences into two or more sentence fragments. The method further identifies complete paragraphs from the data and separates complete paragraphs into individual sentences. The method then combines sentence fragments from a single sentence to form positive sentence fragment pairings, as well as combining complete sentences from a single paragraph to form positive sentence pairings at block 240, and combines sentence fragments from different sentences to form negative sentence fragment pairings, and sentences from different paragraphs to form negative sentence pairings, at block 250.

At block 260, the method fine tunes the generic ML model of block 210 suing the positive and negative sentence fragment or sentence pairings and a loss function such as a noise contrastive estimator loss function, for predicting a probability that any particular pairing should or should not be joined. In an embodiment, the method identifies one or more predicted probability thresholds from the training data indicating the break or interface between predicted probabilities for negative sentence fragment or sentence pairings and predicted probabilities for positive sentence fragment or sentence pairings, the method determines relative similarities between sentence fragment or sentence pairing elements in determining the NCE los function predicted probability. The fine tuning yields two distinct ML models, one trained to segment sentence fragments and one trained to segment sentences.

In an embodiment, the method utilizes a portion of the cleaned training data as a validation dataset and analyzes this data using the trained model to validate that the current model weights from the training have yielded a model to successfully segment the training data. Training continues until validation indicates model node weights able to successfully segment the validation dataset text.

In an embodiment, the method provides the trained model for the purpose of segmenting new text data. The new text data may comprise unstructured or well structured text data in need of text segmentation prior to further NLP or NLU processing.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed. In an embodiment, the method executes on a computing environment including a communications network as well as edge cloud and/or cloud computing resources.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

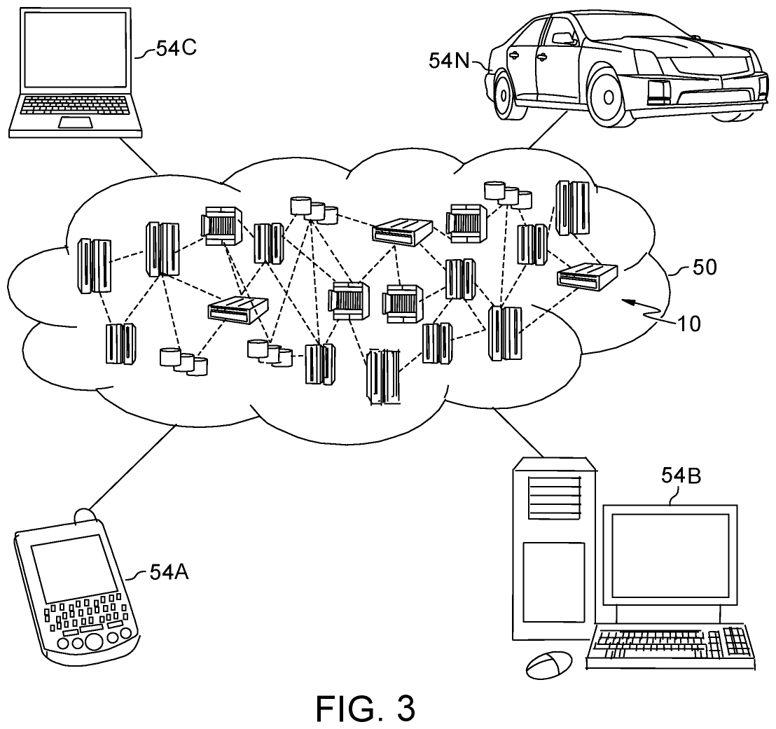

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

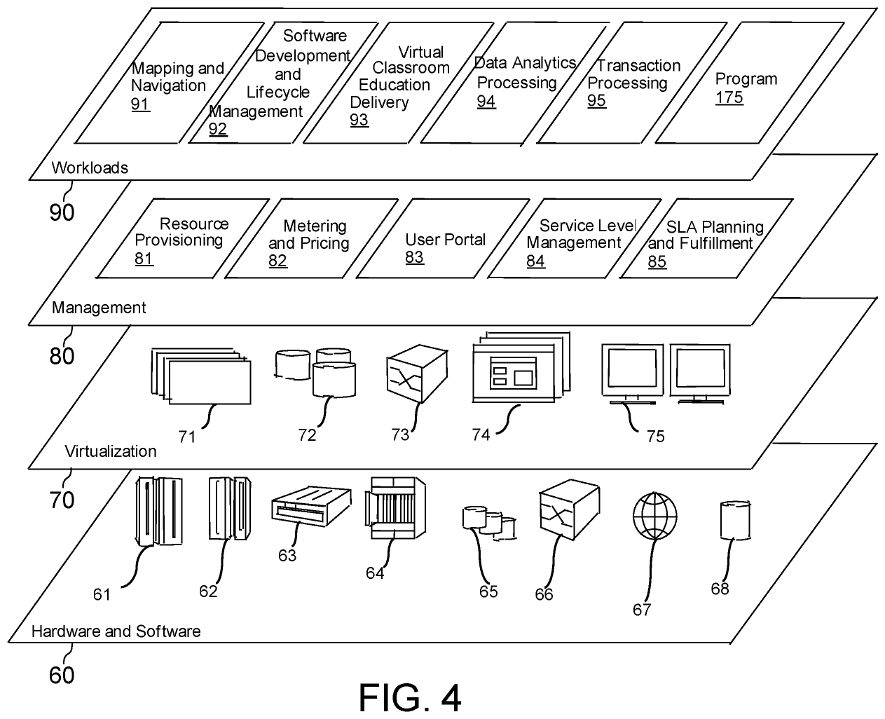

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and text segmentation program 175.

The present invention may be a system, a method, and/or a computer program product at any possible technical detail level of integration. The invention may be beneficially practiced in any system, single or parallel, which processes an instruction stream. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, or computer readable storage device, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions collectively stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer system for training a text segmentation model, the computer system comprising:
one or more computer processors;
one or more computer readable storage devices; and
stored program instructions on the one or more computer readable storage devices for execution by the one or more computer processors, the stored program instructions comprising:
program instructions to receive a machine learning (ML) model for language processing;
program instructions to receive segmentable text, the segmentable text comprising properly joined segments;
program instructions to separate properly joined segments of the text into separate segments;
program instructions to generate positive segment pairs comprising properly joined segments;
program instructions to generate negative sentence fragment pairs comprising a first segment and a second segment, wherein the first segment and the second segment are not properly joined; and
program instructions to train the ML model using the positive segment pairs and the negative segment pairs, and a contrastive self-supervised learning framework training objective loss function.

2. The computer system according to claim 1, wherein the contrastive self-supervised learning framework training objective loss function comprises a noise contrastive estimator loss function predicting a probability for joining two sentence fragments.

3. The computer system according to claim 1, the stored program instructions further comprising program instructions to separate the text into sentence fragments, wherein each sentence is separated into at least two sentence fragments;
program instructions to generate positive sentence fragment pairs comprising sentence fragments from a single sentence;
program instructions to generate negative sentence fragment pairs comprising a first sentence fragment from a first sentence and a second sentence fragment from a second sentence; and
program instructions to train a second ML model using the positive sentence fragment pairs and the negative sentence fragment pairs, and a contrastive self-supervised learning framework training objective loss function.

4. The computer system according to claim 3, the stored program instructions further comprising:
program instructions to provide new text to the trained ML model, the new text comprising sentence fragments; and
program instructions to join two sentence fragments of the new text, forming a complete sentence.

5. The computer system according to claim 1, the stored program instructions further comprising program instructions to apply a smoothing function to the noise contrastive estimator predictions.

6. The computer system according to claim 1, the stored program instructions further comprising
program instructions to separate paragraphs of the text into sentences, wherein each paragraph is separated into at least two sentences;
program instructions to generate positive sentence pairs comprising sentences from a single paragraph;
program instructions to generate negative sentence pairs comprising a first sentence from a first paragraph and a second sentence from a second paragraph; and
program instructions to train a second ML model using the positive sentence pairs and the negative sentence pairs, and a contrastive self-supervised learning framework training objective loss function.

7. The computer system according to claim 6, the stored program instructions further comprising:
program instructions to provide new text to the trained ML model, the new text comprising sentences; and
program instructions to join two sentences of the new text, forming a multi-sentence section of text.

8. A computer program product for training a text segmentation model, the computer program product comprising one or more computer readable storage devices and collectively stored program instructions on the one or more computer readable storage devices, the stored program instructions comprising:
program instructions to receive a machine learning (ML) model for language processing;
program instructions to receive segmentable text, the segmentable text comprising properly joined segments;
program instructions to separate properly joined segments of the text into separate segments;
program instructions to generate positive segment pairs comprising properly joined segments;
program instructions to generate negative sentence fragment pairs comprising a first segment and a second segment, wherein the first segment and the second segment are not properly joined; and
program instructions to train the ML model using the positive segment pairs and the negative segment pairs, and a contrastive self-supervised learning framework training objective loss function.

9. The computer program product according to claim 8, wherein the contrastive self-supervised learning framework training objective loss function comprises a noise contrastive estimator loss function predicting a probability for joining two sentence fragments.

10. The computer program product according to claim 9, the stored program instructions further comprising:
program instructions to separate the text into sentence fragments, wherein each sentence is separated into at least two sentence fragments;
program instructions to generate positive sentence fragment pairs comprising sentence fragments from a single sentence;
program instructions to generate negative sentence fragment pairs comprising a first sentence fragment from a first sentence and a second sentence fragment from a second sentence; and
program instructions to train a second ML model using the positive sentence fragment pairs and the negative sentence fragment pairs, and a contrastive self-supervised learning framework training objective loss function.

11. The computer program product according to claim 10, the stored program instructions further comprising:
program instructions to receive new text to the trained ML model, the new text comprising at least two sentence fragments of text; and
program instructions to join two sentence fragments of text of the new text, forming a complete sentence.

12. The computer program product according to claim 8, the stored program instructions further comprising
program instructions to separate paragraphs of the text into sentences, wherein each paragraph is separated into at least two sentences;
program instructions to generate positive sentence pairs comprising sentences from a single paragraph;
program instructions to generate negative sentence pairs comprising a first sentence from a first paragraph and a second sentence from a second paragraph; and
program instructions to train a second ML model using the positive sentence pairs and the negative sentence pairs, and a contrastive self-supervised learning framework training objective loss function.

13. The computer program product according to claim 12, the stored program instructions further comprising:
program instructions to provide new text to the trained ML model, the new text comprising sentences; and
program instructions to join two sentences of the new text, forming a multi-sentence section of text.

14. A computer implemented method for training a text segmentation model, the method comprising:
receiving, by one or more computer processors, a machine learning (ML) model for language processing;
receiving, by the one or more computer processors, segmentable text, the segmentable text comprising properly joined segments;
separating, by the one or more computer processors, properly joined segments of the segmentable text into separate segments;
generating, by the one or more computer processors, positive segment pairs comprising properly joined segments;
generating, by the one or more computer processors, negative sentence fragment pairs comprising a first segment and a second segment, wherein the first segment and the second segment are not properly joined; and
training, by the one or more computer processors, the ML model using the positive segment pairs and the negative segment pairs, and a contrastive self-supervised learning framework training objective loss function.

15. The computer implemented method according to claim 14, wherein the contrastive self-supervised learning framework training objective loss function comprises a noise contrastive estimator loss function predicting a probability for joining two sentence fragments.

16. The computer implemented method according to claim 15, further comprising
separating, by the one or more computer processors, the text into sentence fragments, wherein each sentence is separated into at least two sentence fragments;
generating, by the one or more computer processors, positive sentence fragment pairs comprising sentence fragments from a single sentence;
generating, by the one or more computer processors, negative sentence fragment pairs comprising a first sentence fragment from a first sentence and a second sentence fragment from a second sentence; and
training, by the one or more computer processors, a second ML model using the positive sentence fragment pairs and the negative sentence fragment pairs, and a contrastive self-supervised learning framework training objective loss function.

17. The computer implemented method according to claim 16, further comprising:
providing, by the one or more computer processors, new text to the trained ML model, the new text comprising sentence fragments; and
joining, by the one or more computer processors, two sentence fragments of the new text, forming a complete sentence.

18. The computer implemented method according to claim 14, further comprising applying, by the one or more computer processors, a smoothing function to the noise contrastive estimator predictions.

19. The computer implemented method according to claim 14, further comprising
separating, by the one or more computer processors, paragraphs of the text into sentences, wherein each paragraph is separated into at least two sentences;
generating, by the one or more computer processors, positive sentence pairs comprising sentences from a single paragraph;
generating, by the one or more computer processors, negative sentence pairs comprising a first sentence from a first paragraph and a second sentence from a second=paragraph; and
training, by the one or more computer processors, a second ML model using the positive sentence pairs and the negative sentence pairs, and a contrastive self-supervised learning framework training objective loss function.

20. The computer implemented method according to claim 19, further comprising:
providing, by the one or more computer processors, new text to the trained ML model, the new text comprising sentences; and
joining, by the one or more computer processors, two sentences of the new text, forming a multi-sentence section of text.
